(19) United States
(12) Patent Application Publication
(10) Pub. No.: US 2003/0177203 A1
(43) Pub. Date: Sep. 18, 2003

(54) Developer tools for web-based education

(75) Inventor: Jay R. Crook, Corpus Christi, TX (US)

Correspondence Address: DOUGLAS S. FOOTE, NCR CORPORATION, 1700 S. PATTERSON BLVD. WHQ5E, WHO-5E, DAYTON, OH, 45479, US

(73) Assignee: NCR Corporation

(21) Appl. No.: 10/097,722

(22) Filed: Mar. 13, 2002

(51) Int. Cl. G06F 15/16; G09B 7/00

(52) U.S. Cl. 709/219; 434/323

(57) ABSTRACT

A network-based educational system. Lessons for a course are received from an instructor in an ordinary word-processor format. The invention converts the lessons into HTML format, or other format suitable to the network being used. The converted lessons are made available to students over the network. Provision is made for administering examinations over the network, and making statistical information available to administrators of the system.

The invention concerns development tools for generating software and documents used in educational courses presented over networks, including private networks and the Internet.

### BACKGROUND OF THE INVENTION

The development of the modern micro-computer, together with the parallel development of powerful networking techniques, provide a nearly ideal framework for the dissemination of information to large numbers of people. The well-known Internet provides an example of such a framework.

This framework is suited to educational applications, wherein information is disseminated to students, and, in addition, feedback is obtained concerning how well the students master the information. Examinations of the students provide one type of feedback.

However, a particular obstacle arises in using this framework for educational purposes because the information disseminated may need to conform to a specific protocol, or format, such as HTML, Hyper Text Mark up Language. Further, even if the specific protocol is not strictly required, adherence to the protocol is almost mandatory in order to give the information an appearance which is (1) pleasing and (2) consistent with other documents presented using the framework.

Therefore, for practical reasons, it is almost mandatory that information disseminated over the Internet, and other networks, conform to the HTML protocol, or one of its variants. Certain aspects of this protocol can be explained by analogy to a document generated by a word processor.

A word processor generates a computer file, which contains the actual informational content of a document. In general, the informational content is stored as alphanumeric characters, encoded according to some standard, such as ASCII.

In addition, the file contains “formatting codes”, which control how the document appears (1) on a computer display and (2) when printed on paper. For example, if a particular passage in the document is to be italicized, the word processor places an italic-code at both the beginning, and at the end, of the passage.

These formatting codes handle numerous types of parameters, such as font type, font size, tabulation, margins, and so on. These codes are inserted automatically by the word processor; the human author is largely uninvolved in entry of the formatting codes.

An HTML document contains similar codes, which are similarly used to control how the document is displayed on a computer display. In addition, the HTML document also contains special codes, or “links,” which act like pushbuttons. That is, when the user sweeps a mouse cursor, or other pointer, over a link displayed on a computer screen (under present technology, the links are ineffective when printed on paper), the mouse cursor generally changes in appearance, as does the link. If the mouse/pointer is actuated at that time, specific action is taken. For example, actuation of the link may cause the user's computer to contact a specific web site and download one, or more, documents.

Thus, both word processor documents and HTML documents contain embedded codes which are similar in function. However, for various technical reasons which will not be fully elaborated here, generation of an HTML document is not so simple as generating a document using a word processor.

For example, in generating an HTML document, one common approach is to first generate a precursor document using a word processor. Then HTML codes are manually inserted. However, manual generation of the HTML codes requires that the author, or instructor in the case of an educational document, attain familiarity with the HTML protocol, which requires an investment of the author's time. Consequently, many authors forego utilizing the Internet and other networks for the dissemination of information.

The invention automates the generation of HTML pages for use in an Internet-based educational system, thereby simplifying Internet access for instructors.

### OBJECTS OF THE INVENTION

An object of the invention is to provide an improved Internet-based educational system.

A further object of the invention is to provide an Internet-based educational system which reduces workload on parties who generate HTML documents.

### SUMMARY OF THE INVENTION

In one form of the invention, ordinary word-processing documents are converted into network-compatible documents, such as HTML documents, without human intervention. The network-compatible documents are stored in a server, and made available to students over the network.

### BRIEF DESCRIPTION OF THE DRAWINGS

FIGS. 1, 4, and 5 are flow charts indicating processes undertaken by different forms of the invention.

FIG. 2 represents a course outline.

FIG. 3 represents an examination question utilized by the invention. The bottom part of the Figure illustrates one page of a conversion from word-processing document format to HTML format.

FIG. 6 illustrates operation of one form of the invention.

### DETAILED DESCRIPTION OF THE INVENTION

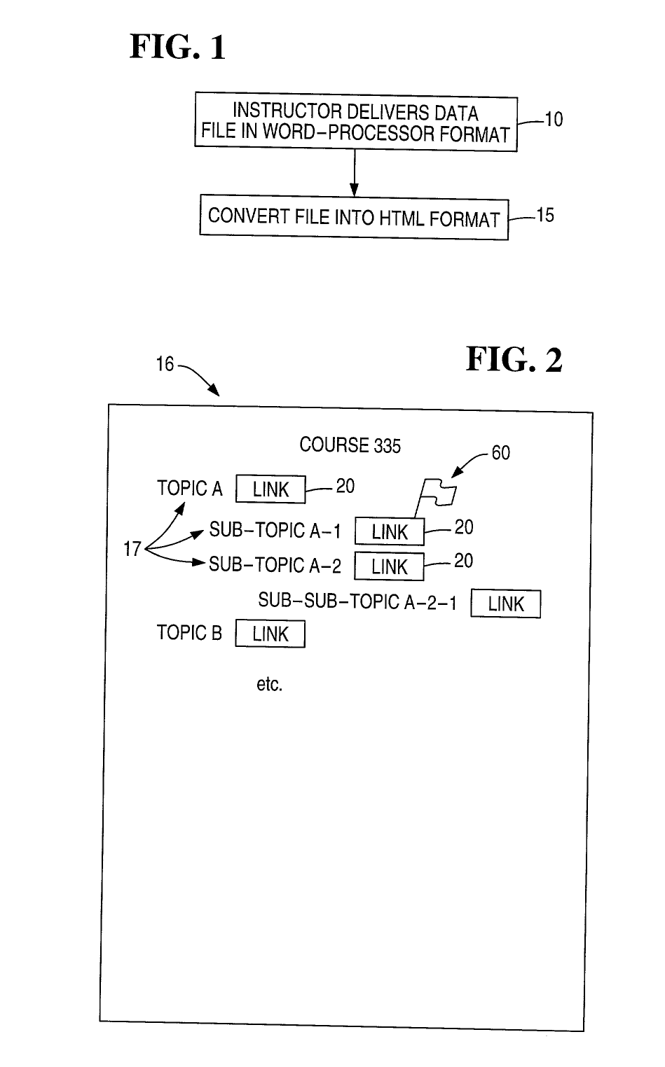

FIG. 1 illustrates a flow chart of procedures undertaken by one form of the invention. Block 10 indicates that an instructor delivers computer-readable documents in a specific word-processing format. One specific format is that utilized by the word-processing package manufactured by Microsoft (TM), under the trademark WORD (TM). For example, the instructor may deliver the documents on a floppy diskette, a Compact Disc (CD), or may transfer computer files electronically.

Block 15 indicates that the invention converts the documents from the word-processing format into HTML format. Software packages which perform this conversion are commercially available. In addition, the conversion can be viewed as a generic translation operation. That is, the documents originally generated by the instructor will contain (1) informational content and (2) formatting codes. The total number of different formatting codes, that is the library of all possible formatting codes, is known, based on the identity of the word processing software, or text editor, used to generate the documents.

The formatting codes are then translated, or converted, into the suitable HTML codes. Such a translation operation is known in the art, and can be handled by the well-known software packages LEX and YACC, which are commonly distributed with the UNIX operating system.

If a given formatting code has no HTML counterpart, several options are available. One is to flag a technician, who selects an appropriate HTML code. A second option is to assign an HTML code by default. A third is to insert a code stating “unknown” into the HTML document. Other possibilities exist.

In addition, links must be added to the document. In one form of the invention, the HTML documents are prepared by the invention, as just described, and then presented to the instructor for insertion of the link information. In another embodiment, the instructor designates the links, and their URL addresses (URL: Uniform Resource Locator) by special codes in the original word processing document. The invention recognizes those codes, and generates the links.

Therefore, as thus far described, the invention performs a translation of the original documents, prepared by the instructor using ordinary word-processor or text editor. The translation results in an HTML-compatible document, with embedded links.

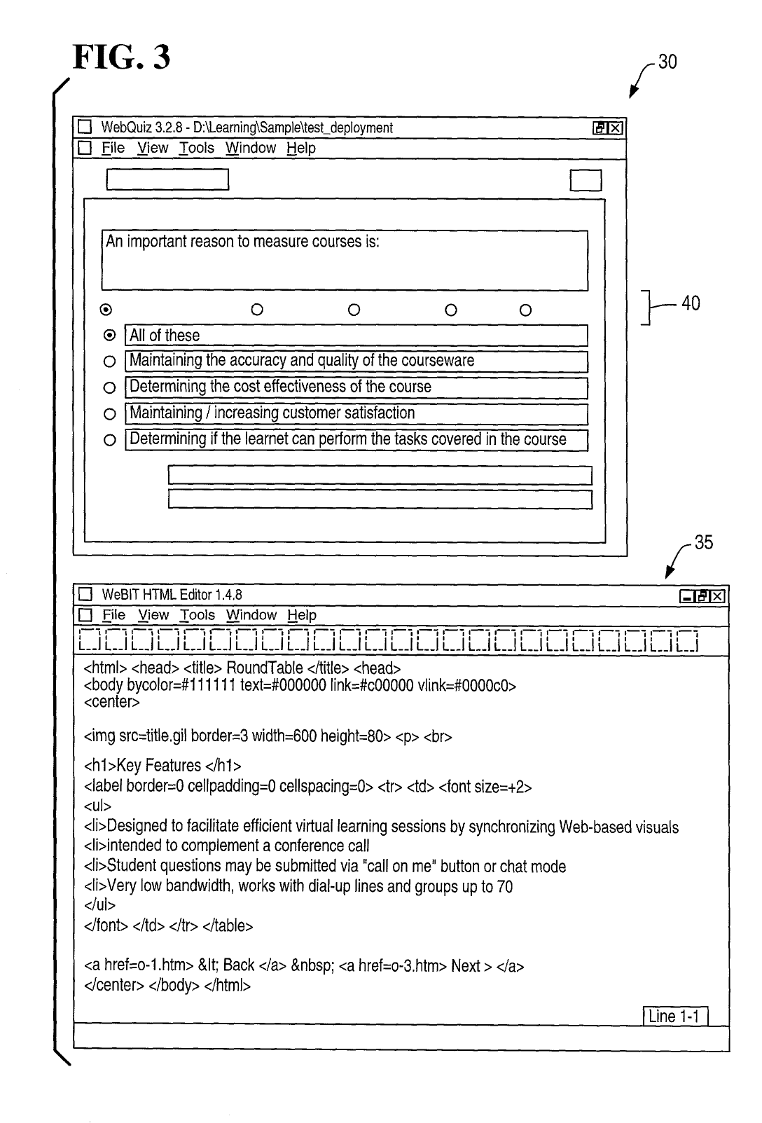

The documents indicated in block 10 can be conceptually divided into two types: (1) course content documents and (2) examination questions. In one form of the invention, item (1), the course content, includes an overall outline for each course, arranged in outline format. FIG. 2 illustrates a representative outline 16. Each outline item 17 is associated with a link 20. Each link leads to a respective document containing course content corresponding to the outline item.

As a simple example, a given course may be presented in the form of thirty one-hour lessons. Each one-hour lesson would be described by an outline item 17, with thirty total outline items 17 being present. The student actuates a link 20 for each one-hour lesson.

Each link 20 identifies a location of the HTML documents relating to that lesson. Actuation of the link causes the HTML documents to be retrieved, and displayed to the student.

The invention stores the examination questions in a library, perhaps grouped into sets of tests. For example, a selected number of tests can be stored, such as three, five, ten, or another number. Each test contains a number of questions, such as twenty-five questions. As another example, a master list of questions is stored.

The invention provides the ability for the student to take a unique test, through selecting random questions from the library, or from the stored tests, and assembling the questions into the test.

For example, if a new test is to be generated, and if five tests are stored, the instructor may select the first six questions from each of the five stored tests, and assemble them into a sixth test, containing thirty questions. In principle, the selection/assembly process amounts to a concatenation of individual test questions into a larger file.

Alternately, the invention can randomly select questions from the library of questions, and formulate the tests automatically. In this case, it may be desirable to group the questions in the library according to content, and randomly select questions from each group, to avoid selecting all questions on a single topic.

For example, if the course in question is calculus, group A may contain questions on differentiation, group B may contain questions on the Chain Rule, group C may contain questions on implicit differentiation, and so on. The Invention randomly selects two questions, for example, from each of groups A through K, for example.

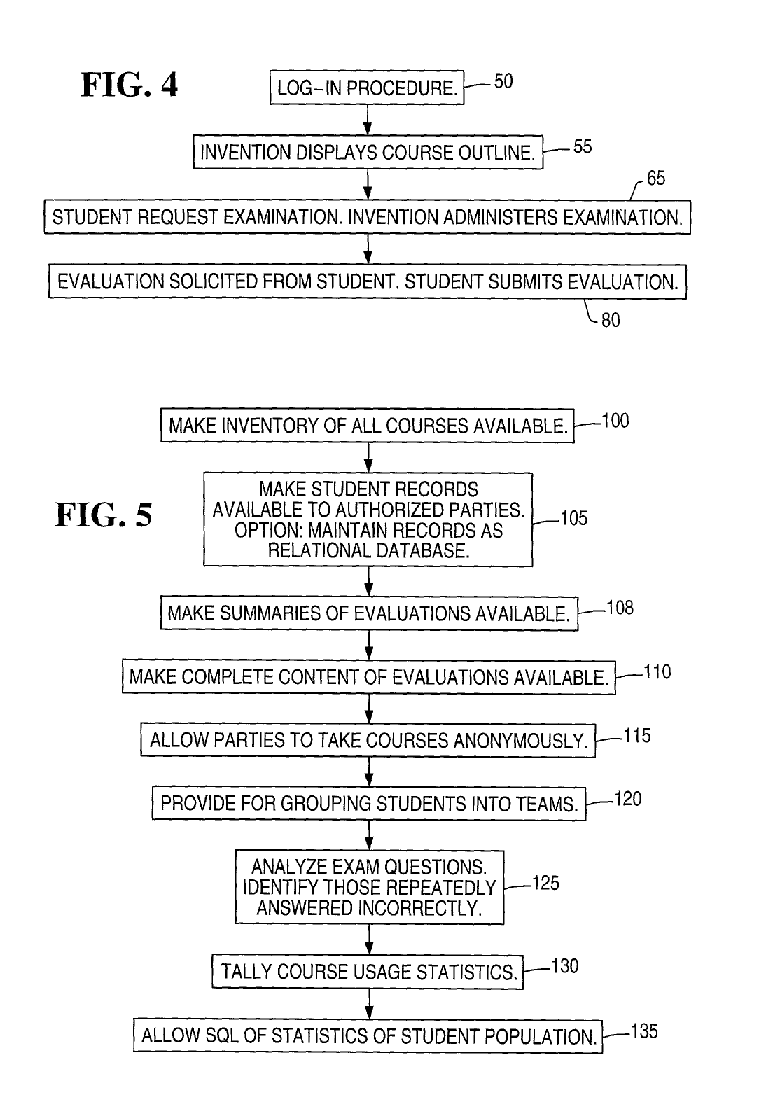

The tests exploit the ability of HTML documents to present material in the form of lists. FIG. 3 illustrates one test question 30. This particular question is presented in the form of a list, in HTML parlance. As option bar 40 indicates, the student is allowed to make one choice. Bar 40 also indicates that, in other questions, different numbers and types of choices may be available, such as (1) true/false responses, (2) multiple choice responses, (3) short answer responses, (4) matching response, and (5) a comment.

FIG. 4 is a chart illustrating processes undertaken when the invention interacts with students. It is emphasized that FIG. 4 is not necessarily sequential, and that all processes in FIG. 4 need not be undertaken in a particular student session.

Block 50 indicates that a student logs into the invention, as by providing a name, electronic mail address, and password. The invention may record the location, or identity, of the computer used by the student using cookies.

Block 55 indicates that the invention displays the outline of the course, together with an indication of which outline items have been completed, as by flagging those items for which tests have been passed by the student. Flags 60 in FIG. 2 provide an example of flagging. The student selects an outline item, as by actuating a link 20 in FIG. 2. The invention presents the course content for that item to the student.

Block 55 is a default display, displaying the course outline of the last course with which the student interacted. Prior to display of block 55, or in conjunction with block 55, the option may be given to display all available courses, as in block 100 in FIG. 5.

When the student, through self-assessment, concludes readiness to take the test for the outline item, the invention presents a test to the student, as indicated by block 65. As stated above, the invention may assemble a test by randomly selecting a set of questions from a larger library provided by the instructor.

Block 80 indicates that an evaluation is solicited from the students, either periodically or at the end of a course. In one form of the invention, two types of evaluation are used. One is the standard type, which, in effect, requests that the performance of the instructor be evaluated by the students. The completed instructor-evaluation are passed along to the instructor.

The other type of evaluation is based on the concept that the developer of the invention is also part of the educational process, and asks questions of the students from that perspective. For example, this evaluation may ask technical questions concerning matters such as (1) could the students log in at the times they wished, (2) was sufficient bandwidth available to present the material rapidly enough to keep up with the students' progress, and so on. These latter evaluations are delivered to the developer, as well as perhaps to the instructor and other administrators of the system.

FIG. 5 is a chart illustrating processes undertaken when the invention interacts with parties other than students, such as instructors and administrators, although it can be envisioned that students may be involved in some blocks. It is again emphasized that FIG. 5 is not necessarily sequential, and that all processes in FIG. 5 need not be undertaken in a particular session.

Block 100 indicates that an inventory of all courses is available. In principle, this inventory corresponds to the “course catalog” of a university.

Block 105 indicates that student records are made available. These records are organized as elements of a relational database, so that various types of sorting can be undertaken. For example, an administrator may wish to learn the grades of all male students who took course X, the male students originating from the states of Ohio, Kentucky, and Indiana, and being under 20 years of age.

The student records indicate the courses each student has taken, the grades received in each, and other identifying information of the student which is commonly contained on a student's academic transcript.

In addition, the student records contain summaries of the evaluations discussed above. For example, one survey question may be, “I rank this course in the top X percent of all courses I have ever taken,” wherein the student is to supply the number X. The summary in question would tabulate all the X's supplied by the student, and state, for example, ⅕ of the students stipulated an X of ten percent, ⅕ stipulated an X of 20 percent, and so on. This summary reporting is indicated in block 108, and is in contrast the full reporting discussed immediately below.

Block 110 indicates that the complete content of all evaluations is made available. In effect, photocopies of all content of all evaluations would be made available.

Block 115 indicates that parties can take the courses as observers. For example, colleagues of a given instructor may wish to take a course, as part of an evaluation of the instructor's qualifications to achieve academic tenure. As another example, developers of educational systems may wish to take courses. However, the performance of the parties in these two examples should clearly not be combined with that of students taking the courses. For instance, the colleagues of the first example can be expected to attain grades of A in all cases. Grouping them with ordinary students would distort the students' information.

Thus, block 115 indicates that selected parties can participate in the educational system as observers. Data concerning the observers, also called tagged parties, is not co-mingled with the population statistics of normal students. For example, academic grades, or scores, of the observers are not co-mingled. Similarly, demographic data of the observers, such as age, sex, previous education, hometown, etc., is not co-mingled with the similar data of the actual students.

Alternately, the observers can be classified separately from the students, but with identical records kept as for students.

Block 120 indicates that students can be grouped into teams, for group projects. For example, if 50 students take a given course, the instructor may group them into 5 teams. This grouping allows the instructor to, for example, send five different e-mail messages to the five teams, containing instructions for the five different projects.

Block 125 indicates that a statistical analysis is undertaken to identify test questions which are repeatedly answered incorrectly, or answered incorrectly with a frequency which exceeds some threshold. This threshold may be variable, and set by the person making inquiry as to such test questions. For example, the person may request that all test questions which were answered incorrectly Y percent of the time be identified. Identifying such questions may be helpful in evaluating whether the questions were unfair, incorrectly presented, or burdened by some other defect.

Block 130 indicates that course usage statistics are tallied. One tally involves listing the total number of students taking a given course, or taking a given course in one year, and so on. This tally assists in identifying the most popular courses, and the least popular.

Block 135 indicates that various statistics regarding the student population can be generated. For example, an administrator may wish to know items such as (1) how many students are within Z courses of graduation, (2) how many students failed course A in year 1998, and so on. The acronym “SQL” in block 135 refers to Search and Query Language, and is used to refer generically to executing a query on a relational database. The database contains all information about students ordinarily recorded by an educational institution.

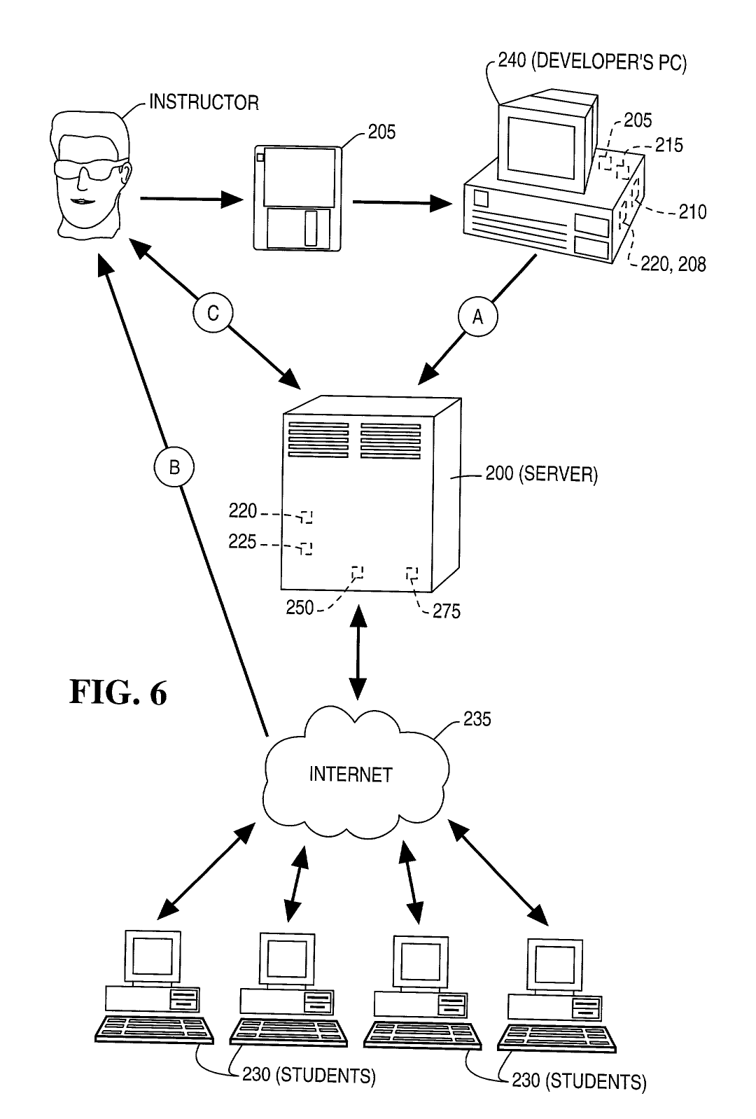

FIG. 6 illustrates one form of the invention. The personal computer, PC, 240 belonging to the instructor or developer of a course, contains documents 205 which contain information content for the course. As explained above, the documents 205 are prepared by the instructor. Documents 205 are delivered to server system 200 in a conventional manner, as by file transfer protocol, FTP, or by mapping to it as a network drive, as indicated by path A.

The server system 200 may be distributed, that is, the individual components of the system 200 need not be situated at a single location.

The PC 240 in FIG. 6 also contains software 210 which converts documents in ordinary word-processing format, represented by block 215, into HTML documents, or other network-compatible documents, represented by block 220. The documents represented by block 220 contain the lessons which are delivered to the students.

While the documents of both block 215 and 220 are similar in the sense that both contain types of formatting codes, in one form of the invention these documents are different. In one form of the invention, the documents of block 215 do not contain links.

Server system 200 contains software and hardware 225 necessary to present the course documents 220 to students' terminals 230 by way of the network 235. In concept, the server system 200 acts as a web site on the network 235, such as the Internet, and the individual lessons act as web pages.

Server system 200 also contains software and hardware 250 necessary to (1) deliver examinations to the PCs or terminals 230, (2) receive the answers from the terminals 230, and (3) grade the answers. In concept, the answers take the form of data packets, and are a digital counterpart to the well-known “answer sheet” having bubbles filled with graphite-based number 2 pencils.

Block 275 represents software and hardware which implement the processes indicated in the flow charts of FIGS. 1, 4, and 5, and other processes described herein.

Additional features of FIG. 6 are the following. Software and hardware within PC 240 perform several functions. One is to convert documents delivered by the instructor, in a DOC (document) format, into HTML format.

Another function is to allow the instructor to select graphical designs, from a stored library of graphical designs, to create a particular look-and-feel of the material presented. In one form of the invention, the look-and-feel is initially established for one page, or lesson, and the invention carries the same look-and-feel through the remaining lessons, without further intervention by the instructor.

The look-and-feel can include (1) specific borders around the computer screen, (2) location, size, and font of titles and headers, and so on. From one perspective, the look-and-feel is tantamount to the format of the material displayed on the computer screens on terminals 230, and is analogous to the format of material presented as hard copy, on paper.

A third function is to allow the instructor to select certain features which will accompany the lessons presented to the students. For example, the instructor can elect to allow students to contact him by electronic mail. As another example, the instructor can allow students to search the course materials.

As a third example, the instructor can elect to present surveys to the students, as discussed above. As a fourth example, the instructor can elect to allow students to join a mailing list, whereby the instructor can contact the students in groups. As a fifth example, the instructor can elect to issue certificates to the students upon completion of certain tasks, a course itself, or a selected group of courses.

A fourth function is to allow the instructor to create the course outline discussed above. The instructor can elect that the outline will possess the same look-and-feel described above.

A fifth function of the hardware and software within PC 240 is to allow the instructor to create examinations or tests for the students.

Another feature of FIG. 6 lies in the particular data paths used. The course materials are transferred from the instructor's PC 240 to the server 200, as by FTP, File Transfer Protocol, as indicated by path A. This path may utilize the Internet 235. Alternately, path A may follow a private network.

Student feedback, such as surveys and evaluations, follow path B and are delivered to the instructor. As indicated by path C, the instructor can gain access to reports within the server 200.

A third feature of FIG. 6 relates to features of the system operating on server 200. That system performs several functions. One is to deliver course material to the students. A second is to track student log-ins and test scores. A third is to provide reports for the developers, such as (1) statistics on usage times and hits on sites and (2) statistics and information on the browsers used by students. In this connection, it is repeated out that students using terminals 230 access the system using standard web browsers.

A fourth function is that the server 200 provides the reports, indicated as being accessed by path C. These reports include (1) student scores and other personal information of the students, (2) each student's transcript of the course, (3) statistics on answers to each test question, (4) an archive of student comments, (5) statistics on the student surveys, and (6) the groupings of students, if any.

### Additional Considerations

1. In an example discussed above, the invention made a conversion from a word-processing file to an HTML file, without human intervention. Then, the invention added links to the HTML file. In this form of the invention, the word-processing document contained no links, or information, such as URLS, from which links can be generated.

In another form of the invention, the word-processing document does contain link information, and the invention generates the entire HTML document, including links, without human intervention.

2. In FIG. 6, it is likely that the links 20 in the outline of FIG. 2 will point to documents stored within the server system 200. However, in the general case, those documents can be stored any place which is accessible through the network 235.

3. The course outline 16 of FIG. 2 is not the only type of document containing links 20. The lessons themselves (not shown, but represented by block 220 in FIG. 6) will, in general, contain links to other documents.

Numerous substitutions and modifications can be undertaken without departing from the true spirit and scope of the invention. What is desired to be secured by Letters Patent is the invention as defined in the following claims.

1. A method, comprising:
a) receiving one or more original documents arranged in a first format;
b) without human intervention, converting the original documents into second documents arranged in a second format; and
c) making the second documents available on a network.

2. Method according to claim 1, wherein the second format is consistent with an HTML standard.

3. Method according to claim 1, wherein the original documents contain word-processing formatting codes, but no links to URLs.

4. Method according to claim 1, wherein the original documents contain both (1) informational content and (2) tests which include examination questions.

5. Method according to claim 4, wherein each test is associated with a respective group of documents containing informational content.

6. Method according to claim 5, and further comprising:
d) delivering one or more tests to a person over the network;
e) receiving test answers; and
f) evaluating correctness of the answers.

7. Method according to claim 6, and further comprising:
g) deriving a score for the test;
h) storing the score; and
i) making the score available to the person and at least one other person.

8. Method according to claim 1 wherein the network comprises the Internet.

9. Method according to claim 1, wherein the second format conforms to an HTML standard, with the exception that links are not contained in the second documents, and further comprising:
d) receiving link-information from a person; and
e) generating links in the second documents, based on the information.

10. A method, comprising:
a) receiving one or more original documents arranged in a first format, the documents containing informational material and tests;
b) without human intervention, converting the original documents into second documents in a second format which is consistent with an HTML standard, and, with human intervention, inserting links into at least some of the second documents;
c) making the second documents available on a network;
d) accepting a request for a test, and delivering the test to the network;
e) receiving answers to the test, and, based on the answers, developing a score; and
f) storing the score, and making the score available to at least two persons.

11. A system, comprising:
a) a server system comprising one or more servers;
b) stored within, or available to, the server system,
i) means for accepting precursor documents which lack links; and
ii) means for adding links to the precursor documents, thereby producing lesson-documents; and
iii) means for making the lesson-documents available over a network.

12. System according to claim 11, wherein the precursor documents contain informational content documents and examination documents, and further comprising:
c) means for making examination documents available over the network.

13. System according to claim 12, and further comprising:
d) means for receiving answers given in response to the examination documents.
